(19) United States
(12) Patent Application Publication
(10) Pub. No.: US 2023/0046431 A1
(43) Pub. Date: Feb. 16, 2023

(54) SYSTEM AND METHOD FOR GENERATING 3D OBJECTS FROM 2D IMAGES OF GARMENTS

(71) Applicant: Myntra Designs Private Limited, Bangalore (IN)

(72) Inventors: Vikram GARG, Rajasthan (IN); Sahib MAJITHIA, Punjab (IN); Sandeep Narayan P, Kerala (IN); Avinash SHARMA, Telangana (IN)

(73) Assignee: Myntra Designs Private Limited, Bangalore (IN)

(21) Appl. No.: 17/551,343

(22) Filed: Dec. 15, 2021

(30) Foreign Application Priority Data
Aug. 16, 2021 (IN) 202141037135

(51) Int. Cl. G06Q 30/06; G06T 17/00; G06T 11/00; G06V 10/774; G06T 19/20

(52) U.S. Cl. CPC G06Q 30/0643; G06T 17/00; G06T 11/001; G06V 10/774; G06T 19/20; G06T 2210/16; G06T 2219/2004

(57) ABSTRACT

A system for generating three-dimensional (3D) objects from two-dimensional (2D) images of garments is presented. The system includes a data module configured to receive a 2D image of a selected garment and a target 3D model. The system further includes a computer vision model configured to generate a UV map of the 2D image of the selected garment. The system moreover includes a training module configured to train the computer vision model based on a plurality of 2D training images and a plurality of ground truth (GT) panels for a plurality of 3D training models. The system furthermore includes a 3D object generator configured to generate a 3D object corresponding to the selected garment based on the UV map generated by a trained computer vision model and the target 3D model. A related method is also presented.

### PRIORITY STATEMENT

The present application claims priority under 35 U.S.C. § 119 to Indian patent application number 202141037135 filed Aug. 16, 2021, the entire contents of which are hereby incorporated herein by reference.

### BACKGROUND

Embodiments of the present invention generally relate to systems and methods for generating 3D objects from 2D images of garments, and more particularly to systems and methods for generating 3D objects from 2D images of garments using a trained computer vision model.

Online shopping (e-commerce) platforms for fashion items, supported in a contemporary Internet environment, are well known. Shopping for clothing items online via the Internet is growing in popularity because it potentially offers shoppers a broader range of choices of clothing in comparison to earlier off-line boutiques and superstores.

Typically, most fashion e-commerce platforms show catalog images with human models wearing the clothing items. The models are shot in various poses and the images are cataloged on the e-commerce platforms. However, the images are usually presented in a 2D format and thus lack the functionality of a 3D catalog. Moreover, shoppers on e-commerce platforms may want to try out different clothing items on them in a 3D format before making an actual online purchase of the item. This will give them the experience of “virtual try-on”, which is not easily available on most e-commerce shopping platforms.

However, the creation of a high-resolution 3D object for a clothing item may require expensive hardware (e.g., human-sized style-cubes, etc.) as well as costly setups in a studio. Further, it may be challenging to render 3D objects for clothing with high-resolution texture. Furthermore, conventional rendering of 3D objects may be time-consuming and not amenable to efficient cataloging in an e-commerce environment.

Thus, there is a need for systems and methods that enable faster and cost-effective 3D rendering of clothing items with high-resolution texture. Further, there is a need for systems and methods that enable the shoppers to virtually try on the clothing items in a 3D setup.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for generating three-dimensional (3D) objects from two-dimensional (2D) images of garments is presented. The system includes a data module configured to receive a 2D image of a selected garment and a target 3D model. The system further includes a computer vision model configured to generate a UV map of the 2D image of the selected garment. The system moreover includes a training module configured to train the computer vision model based on a plurality of 2D training images and a plurality of ground truth (GT) panels for a plurality of 3D training models. The system furthermore includes a 3D object generator configured to generate a 3D object corresponding to the selected garment based on the UV map generated by a trained computer vision model and the target 3D model.

According to another example embodiment, a system configured to virtually fit garments on consumers by generating three-dimensional (3D) objects from two-dimensional (2D) images of garments is presented. The system includes a 3D consumer model generator configured to generate a 3D consumer model based on one or more information provided by a consumer. The system further includes a data module configured to receive a 2D image of a selected garment and the 3D consumer model. The system furthermore includes a computer vision model configured to generate a 2D map of the 2D image of the selected garment, and a training module configured to train the computer vision model based on a plurality of 2D training images and a plurality of ground truth (GT) panels for a plurality of 3D training models. The system moreover includes a 3D object generator configured to generate a 3D object corresponding to the selected garment based on the UV map generated by a trained computer vision model and the 3D consumer model, wherein the 3D object is the 3D consumer model wearing the selected garment.

According to another example embodiment, a method for generating three-dimensional (3D) objects from two-dimensional (2D) images of garments is presented. The method includes receiving a 2D image of a selected garment and a target 3D model. The method further includes training a computer vision model based on a plurality of 2D training images and a plurality of ground truth panels for a plurality of 3D training models. The method furthermore includes generating a UV map of the 2D image of the selected garment based on the trained computer vision model, and generating a 3D object corresponding to the selected garment based on the UV map generated by a trained computer vision model and the target 3D model.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example system for generating 3D objects from 2D images of garments, according to some aspects of the present description,

FIG. 2 is a block diagram illustrating an example computer vision model, according to some aspects of the present description,

FIG. 3 illustrates an example workflow of a computer vision model, according to some aspects of the present description,

FIG. 4 illustrates example landmark prediction by a landmark and segmental parsing network in 2D images, according to some aspects of the present description,

FIG. 5 illustrates example segmentations by a landmark and segmental parsing network in 2D images, according to some aspects of the present description,

FIG. 6 illustrates an example workflow for a texture mapping network, according to some aspects of the present description,

FIG. 7 illustrates an example workflow for an inpainting network, according to some aspects of the present description,

FIG. 8 illustrates an example workflow for identifying 3D poses by a 3D training model generator, according to some aspects of the present description,

FIG. 9 illustrates an example for draping garment panels on a 3D training model by a 3D training model generator, according to some aspects of the present description,

FIG. 10 illustrates an example workflow for generating training data by a training data generator, according to some aspects of the present description,

FIG. 11 illustrates an example workflow for generating a 3D object from a 2D image using a UV map, according to some aspects of the present description,

FIG. 12 illustrates a flow chart for generating a 3D object from a 2D image using a UV map, according to some aspects of the present description,

FIG. 13 illustrates a flow chart for generating training data, according to some aspects of the present description,

FIG. 14 illustrates a flow chart for generating a UV map from a computer vision model, according to some aspects of the present description,

FIG. 15 illustrates a flow chart for generating a UV map from a computer vision model, according to some aspects of the present description, and

FIG. 16 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide systems and methods for generating 3D objects from 2D images of garments using a trained computer vision model. Some embodiments of the present description provide systems and methods to virtually fit garments on consumers by generating 3D objects including 3D consumer models wearing a selected garment.

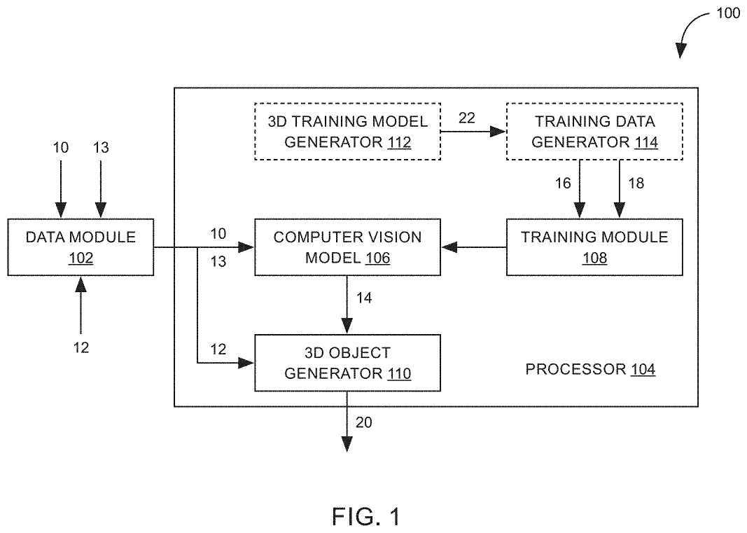

FIG. 1 illustrates an example system 100 for generating three-dimensional (3D) objects from two-dimensional (2D) images of garments. The system 100 includes a data module 102 and a processor 104. The processor 104 includes a computer vision model 106, a training module 108, and a 3D object generator 110. Each of these components is described in detail below.

The data module 102 is configured to receive a 2D image 10 of a selected garment, a target 3D model 12, and one or more garment panels 13 for the selected garment. Non-limiting examples of a suitable garment may include top-wear, bottom-wear, and the like. The 2D image 10 may be a standalone image of the selected garment in one embodiment. The term “standalone image” as used herein refers to the image of the selected garment by itself and does not include a model or a mannequin. In certain embodiments, the 2D image 10 may be a flat shot image of the selected garment. The flat shot images may be taken from any suitable angle and include top-views, side views, front-views, back-views, and the like. In another embodiment, the 2D image 10 may be an image of a human model or a mannequin wearing the selected garment taken from any suitable angle.

In one embodiment, the 2D image 10 of the selected garment may correspond to a catalog image selected by a consumer on a fashion retail platform (e.g., a fashion e-commerce platform). In such embodiments, the systems and methods described herein provide for virtual fitting of the garment by the consumer. The data module 102 in such instances may be configured to access the fashion retail platform to retrieve the 2D image 10.

In another embodiment, the 2D image 10 of the selected garment may correspond to a 2D image from a fashion e-catalog that needs to be digitized in a 3D form. In such embodiments, the 2D image 10 of the selected garment is stored in a 2D image repository (not shown) either locally (e.g., in a memory coupled to the processor 104) or in a remote location (e.g., cloud storage, offline image repository and the like). The data module 102 in such instances may be configured to access the 2D image repository to retrieve the 2D image 10.

With continued reference to FIG. 1, the data module 102 is further configured to receive a target 3D model 12. The term “target 3D model” as used herein refers to a 3D model having one or more characteristics that are desired in the generated 3D object. For example, in some embodiments, the target 3D model 12 may include a plurality of 3D catalog models in different poses. In such embodiments, the target 3D model may be stored in a target model repository (not shown) either locally (e.g., in a memory coupled to the processor 104) or in a remote location (e.g., cloud storage, offline image repository, and the like). The data module 102 in such instances may be configured to access the target model repository to retrieve the target 3D model 12.

Alternatively, for embodiments involving consumers virtually trying on the selected garments, the target 3D model 12 may be a 3D consumer model generated based on one or more inputs (e.g., body dimensions, height, body shape, skin tone and the like) provided by a consumer. In such embodiments, as described in the detail later, the system 100 may further include a 3D consumer model generator configured to generate a target 3D model 12 of the consumer, based on the inputs provided. Further, in such embodiments, the data module 102 may be configured to access the target 3D model 12 from the 3D consumer model generator.

The data module 110 is further configured to receive information on one or more garments panels 13 corresponding to the selected garment. The term “garment panel” as used herein refers to panels used by fashion designers to stitch the garment. The one or more garment panels 13 may be used to generate a fixed UV map as described herein later.

Referring back to FIG. 1, the processor 104 is communicatively coupled to the data module 102. The processor 104 includes a computer vision model 106 configured to generate a UV map 14 of the 2D image 10 of the selected garment. The term “UV mapping” as used herein refers to the 3D modeling process of projecting a 2D image to a 3D model's surface for texture mapping. The term “UV map” as used herein refers to the bidimensional (2D) nature of the process, wherein the letters “U” and “V” denote the axes of the 2D texture.

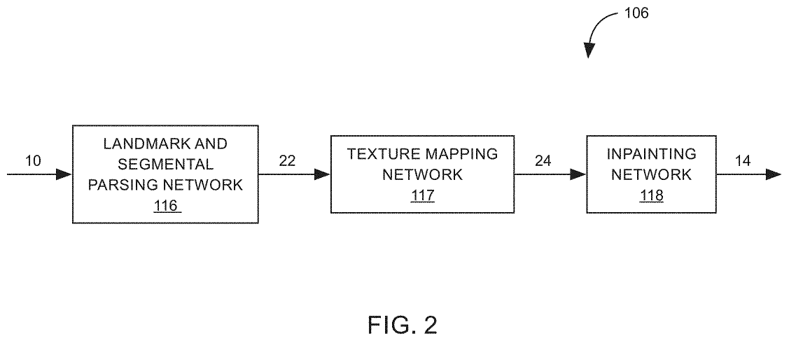

The computer vision model 106, as shown in FIG. 2, further includes a landmark and segmental parsing network 116, a texture mapping network 117, and an inpainting network 118. The landmark and segmental parsing network 116 is configured to provide spatial information 22 corresponding to the 2D image 10. The texture mapping network 117 is configured to warp/map the 2D image 10 onto a fixed UV map, based on the spatial information 22 corresponding to the 2D image, to generate a warped image 24. The inpainting network 118 is configured to add texture to one or more occluded portions in the warped image 24 to generate the UV map 14.

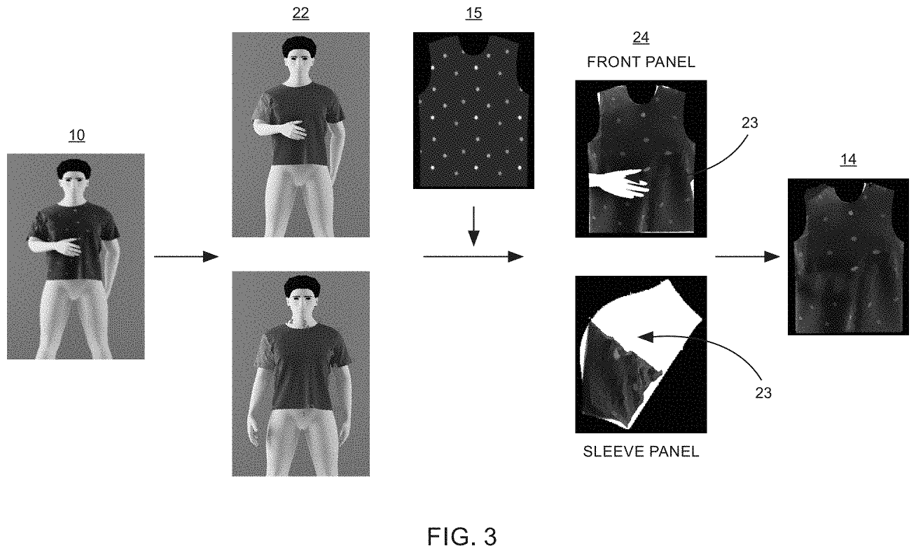

This is further illustrated in FIG. 3, wherein the 2D image 10 is an image of a model wearing a shirt as the selected garment. Spatial information 22 corresponding to the 2D image 10 is provided by the landmark and segmental parsing network 116, as shown in FIG. 3. The 2D image 10 is mapped/warped on the fixed UV map 15 by the texture mapping network 117, based on the spatial information 22, to generate the warped image 24. The fixed UV map 15 corresponds to one or more garment panels 13 for the selected garment (e.g., the shirt in the 2D image 10), as mentioned earlier. The fixed UV map 15 may be generated by a fixed UV map generator (not shown in the Figures). Further, texture is added to one or more occluded portions 23 in the warped image 24 by the inpainting network 118 to generate the UV map 14.

Non-limiting examples of a suitable landmark and segmental parsing network 116 include a deep learning neural network. Non-limiting examples of a suitable texture mapping network 117 include a computer vision model such as a thin plate splice (tps) model. Non-limiting examples of a suitable inpainting network 118 include a deep learning neural network.

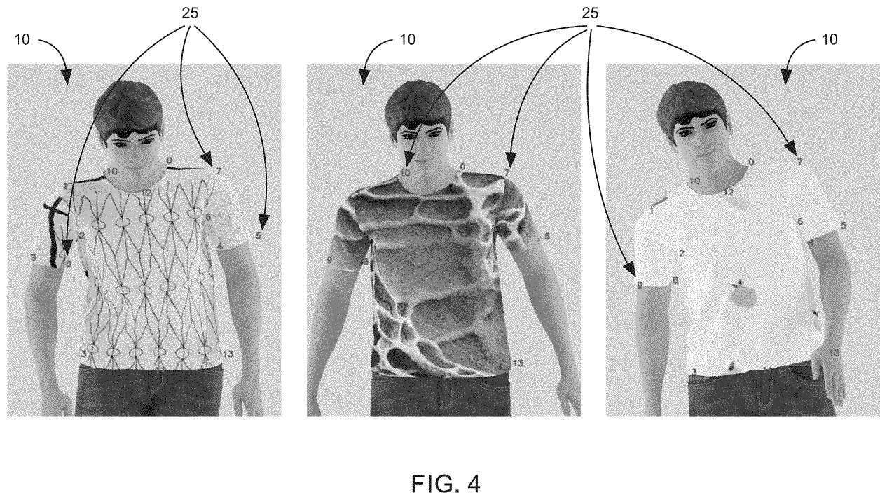

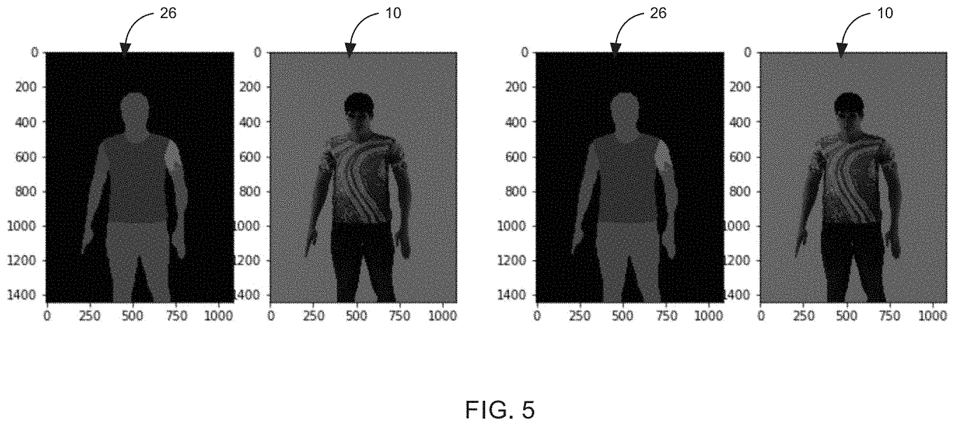

Referring now to FIGS. 4 and 5, the landmark and segmental parsing network 116 is configured to provide a plurality of inferred control points corresponding to the 2D image 10, and the texture mapping network 117 is configured to map the 2D image 10 onto the fixed UV map 15 based on the plurality of inferred control points and a plurality of corresponding fixed control points on the fixed UV map 15.

The spatial information 22 provided by the landmark and segmental parsing network 116 includes landmark predictions 25 (as shown in FIG. 4) and segment predictions 26 (as shown in FIG. 5). The landmarks 25 (as shown by numbers 1-13 in FIG. 4) are used as the inferred control points by the texture mapping network 117 to warp (or map) the 2D image 10 onto the fixed UV map 15.

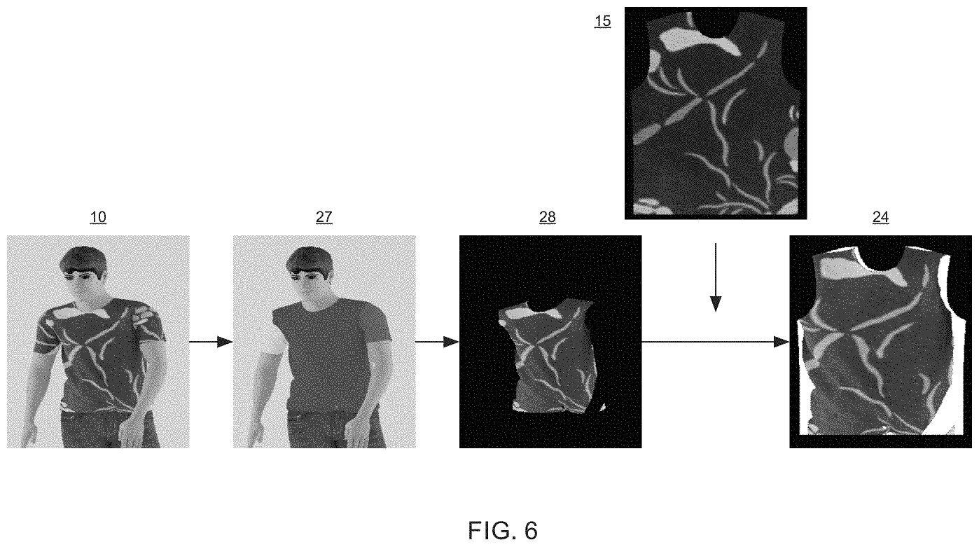

The landmark and segmental parsing network 116 is further configured to generate a segmented garment mask, and the texture mapping network 117 is configured to mask the 2D image 10 with the segmented garment mask and map the masked 2D image onto the fixed UV map 15 based on the plurality of inferred control points. This is further illustrated in FIG. 6 wherein the segmented garment mask 27 is generated from the 2D image 10 by the landmark and segmental parsing network 116. The input image 10 is masked with the segmented image 27 to generate the masked 2D image 28 by the texture mapping network 117.

The texture mapping network 117 is further configured to warp/map the masked 2D image 28 on the fixed UV map 15 based on the plurality of inferred control points 23 to generate the warped image 24. Thus, the texture mapping network 117 is configured to map only segmented pixels which helps in reducing occlusions (caused by hands/other garment articles). Further, the texture mapping network 117 allows for interpolation of texture at high resolution.

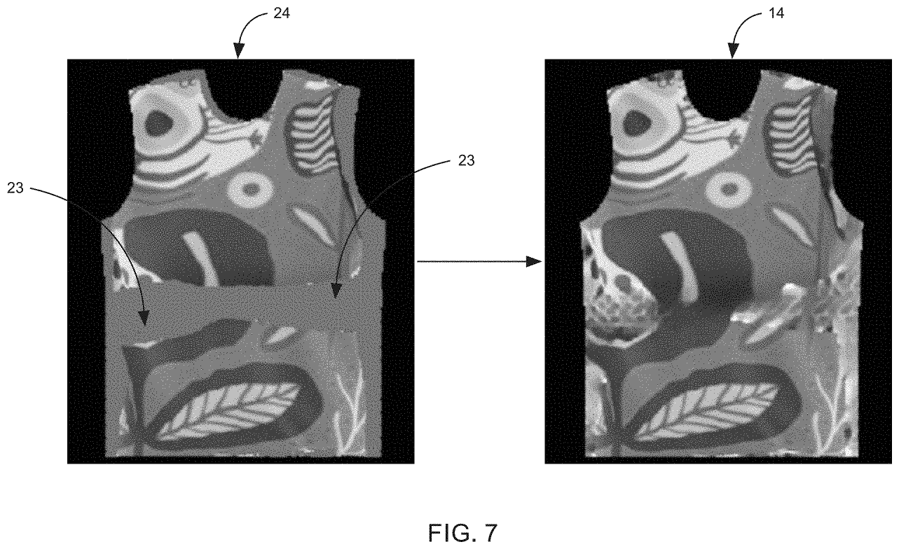

As noted earlier, the inpainting network 118 is configured to add texture to one or more occluded portions in the warped image 26 to generate the UV map 14. This is further illustrated in FIG. 7 where texture is added to occluded portions 23 in the warped image 24 to generate the UV map 14.

The inpainting network 118 is further configured to infer the texture that is not available in the 2D image 10. According to embodiments of the present description, the texture is inferred by the inpainting network 118 by training the computer vision model 106 using synthetically generated data. The synthetic data for training the computer vision model 106 is generated based on a plurality of 2D training images and a plurality of ground truth (GT) panels for a plurality of 3D training models as described below.

Referring again to FIG. 1, the processor 104 further includes a training module 108 configured to train the computer vision model 106 based on a plurality of 2D training images and a plurality of ground truth (GT) panels for a plurality of 3D training models. In some embodiments, the system 100 may further include a 3D training model generator 112 and a training data generator 114, as shown in FIG. 1.

The 3D training model generator 112 is configured to generate the plurality of 3D training models based on a plurality of target model poses and garment panel data. The 3D training model generator 112 is further configured to generate 3D draped garments on various 3D human bodies at scale. In some embodiments, the 3D training model generator 112 includes a 3D creation suite tool configured to create the 3D training models.

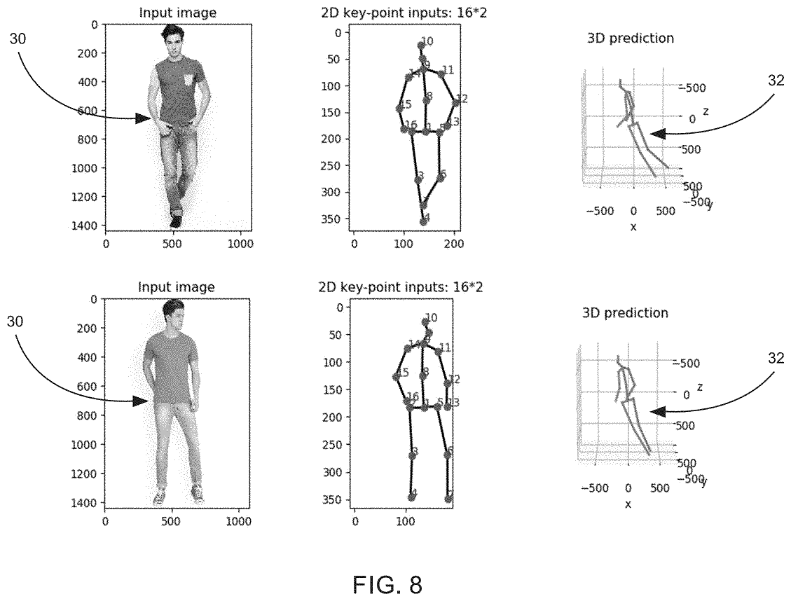

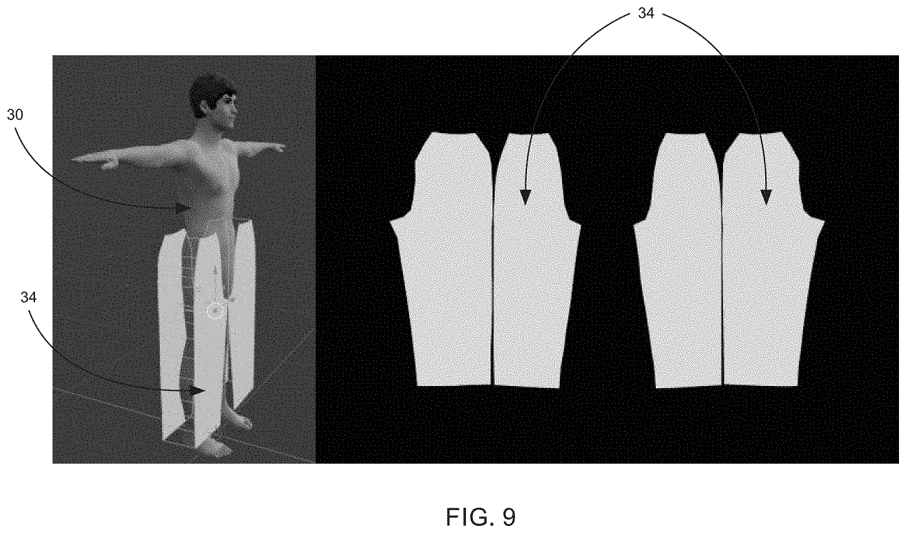

As shown in FIG. 8, the 3D training model generator 112 is first configured to identify a 3D pose 32 of a training model 30, and drape the garment onto the training model 30 in a specific pose. The 3D training model generator 112 is further configured to drape the garment onto the 3D training model 30 by using the information available in clothing panels 34 used by the fashion designers while stitching the garment, as shown in FIG. 9.

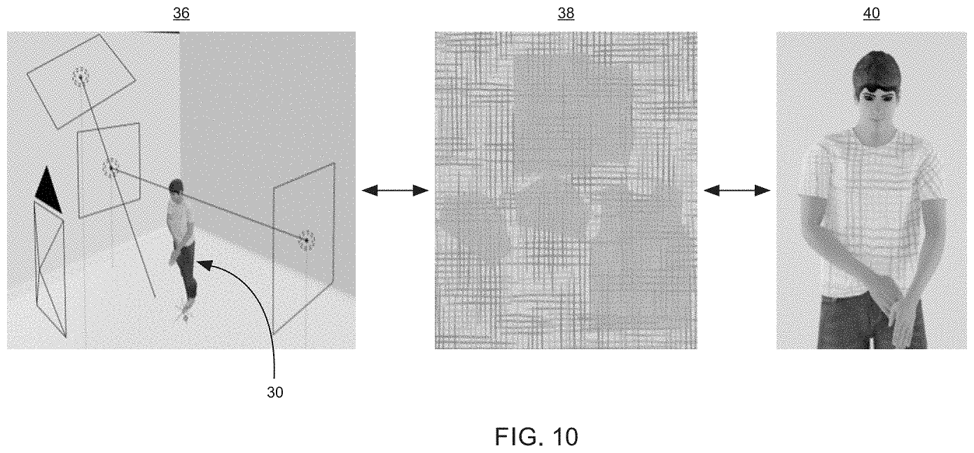

Referring again to FIG. 1, the training data generator 114 is communicatively coupled with the 3D training model generator 112, and configured to generate the plurality of GT panels and the plurality of 2D training images, based on UV maps. This is further illustrated in FIG. 10. As shown in FIG. 10, a 3D training model 30 is placed in a lighted scene 36 along with a camera to generate a training UV map 38 and a 2D training image 40.

The training data generator 114 is configured to use the training UV map 38 to encode the garment texture associated with the 3D training model 30 and for creating a corresponding GT panel. The training data generator 114 is configured to generate a plurality of GT panels and a plurality of 2D training images by varying one or more of model poses, lighting conditions, garment textures, garment colours, or camera angles for a plurality of 3D training models.

Thus, according to embodiments of the present description, the computer vision model 106 is trained using synthetic data generated by the training data generator 114. Therefore, the trained computer vision model 106 is configured to generate a UV map that is a learned UV map, i.e., the UV map is generated based on the training imparted to the computer vision model 106.

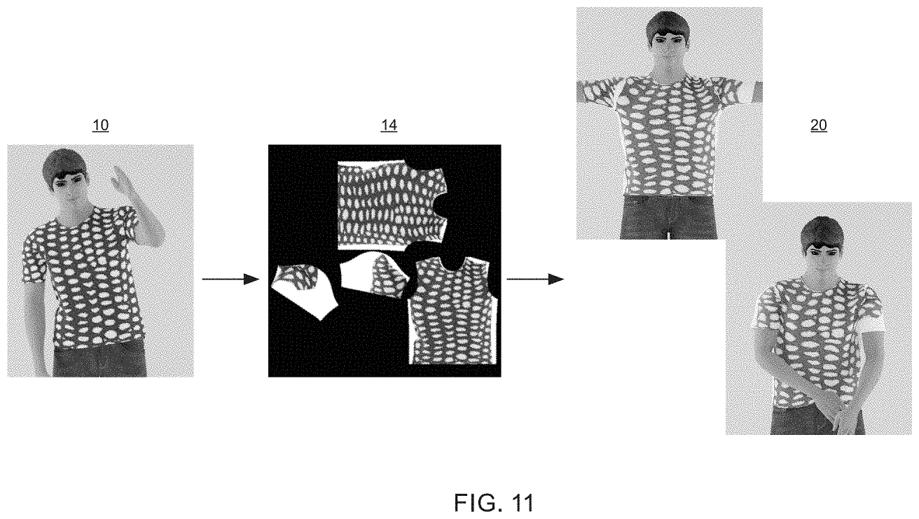

With continued reference to FIG. 1, the processor further includes a 3D object generator configured to generate a 3D object corresponding to the selected garment based on the UV map generated by the trained computer vision model and the target 3D model. This is further illustrated in FIG. 11, where a plurality of 3D objects 20 is generated based on a UV map 14 generated from the 2D image 10. As shown in FIG. 11, the plurality of 3D objects 20 corresponds to a 3D model wearing the selected garment in different poses. In some embodiments, the plurality of 3D objects may correspond to a 3D e-catalog model wearing the selected garment in different poses. In some other embodiments, the plurality of 3D objects may correspond to a 3D consumer model wearing the selected garment in different poses.

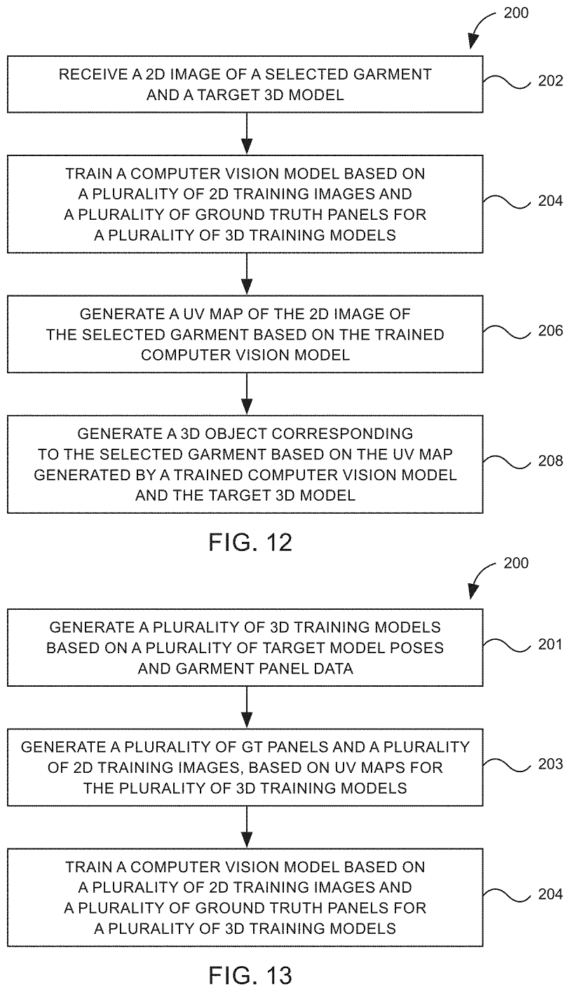

The manner of implementation of the system 100 of FIG. 1 is described below in FIGS. 12-15.

FIG. 12 is a flowchart illustrating a method 200 for generating three-dimensional (3D) objects from two-dimensional (2D) images of garments. The method 200 may be implemented using the systems of FIG. 1, according to some aspects of the present description. Each step of the method 200 is described in detail below.

The method 200 includes, at step 202, receiving a 2D image of a selected garment and a target 3D model. The 2D image may be a standalone image of the selected garment in one embodiment. The term “standalone image” as used herein refers to the image of the selected garment by itself and does not include a model or a mannequin. In another embodiment, the 2D image may be an image of a model or a mannequin wearing the selected garment taken from any suitable angle.

In one embodiment, the 2D image of the selected garment may correspond to a catalog image selected by a consumer on a fashion retail platform (e.g., a fashion e-commerce platform). In another embodiment, the 2D image of the selected garment may correspond to a 2D image from a fashion e-catalog that needs to be digitized in a 3D form.

The term “target 3D model” as used herein refers to a 3D model having one or more characteristics that are desired in the generated 3D object. For example, in some embodiments, the target 3D model may include a plurality of 3D catalog models in different poses. Alternatively, for embodiments involving consumers virtually trying on the selected garments, the target 3D model may be a 3D consumer model generated based on one or more inputs provided by a consumer. In such embodiments, the method 300 may further include generating a target 3D model of the consumer, based on the inputs provided.

Referring again to FIG. 12, the method 200 includes, at step 204, training a computer vision model based on a plurality of 2D training images and a plurality of ground truth panels for a plurality of 3D training models.

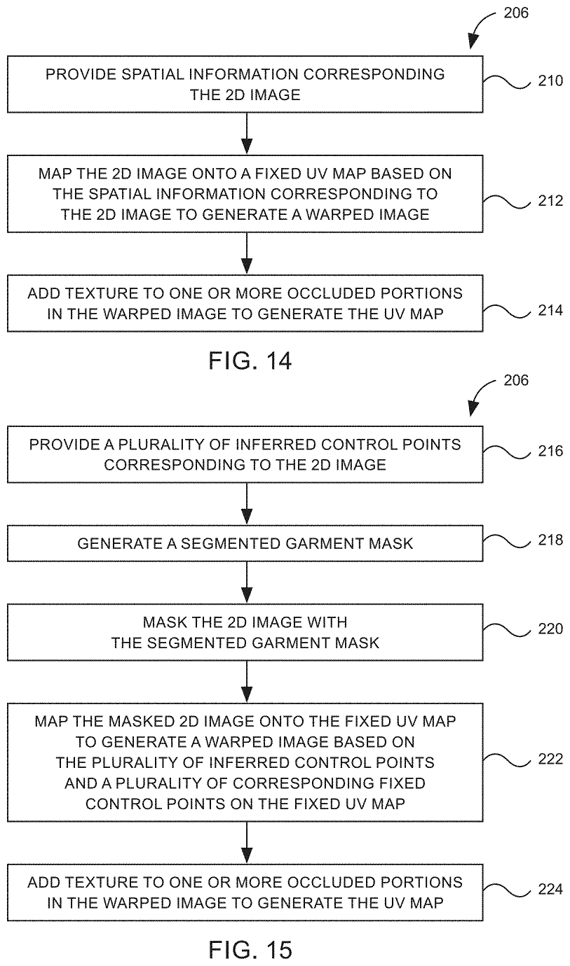

In some embodiments, the method 200 further includes, at step 201, generating a plurality of 3D training models based on a plurality of target model poses and garment panel data, as shown in FIG. 13. The method 200 furthermore includes, at step 203, generating the plurality of ground truth (GT) panels and the plurality of 2D training images, based on UV maps, by varying one or more of model poses, lighting conditions, garment textures, garment colours, or camera angles for the plurality of 3D training models as shown in FIG. 13. The implementation of steps 201 and 203 has been described herein earlier with reference to FIG. 10.

Referring again to FIG. 12, the method 200 includes, at step 206, generating a UV map of the 2D image of the selected garment based on the trained computer vision model. As noted earlier, the computer vision model includes a landmark and segmental parsing network, a texture mapping network, and an inpainting network. Non-limiting examples of a suitable landmark and segmental parsing network include a deep learning neural network. Non-limiting examples of a suitable texture mapping network include a computer vision model such as a thin plate splice (tps) model. Non-limiting examples of a suitable inpainting network include a deep learning neural network.

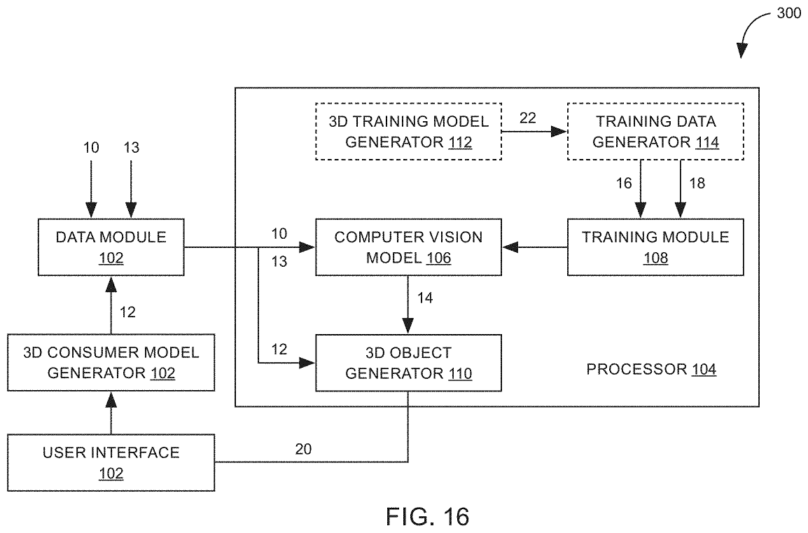

The implementation of step 206 of method 200 is further described in FIG. 14. The step 206 further includes, at block 210, providing spatial information corresponding to the 2D image. The step 206 further includes, at block 212, warping/mapping the 2D image onto a fixed UV map, based on the spatial information corresponding to the 2D image, to generate a warped image. The step 206 further includes, at block 214, adding texture to one or more occluded portions in the warped image to generate the UV map. The fixed UV map corresponds to one or more garment panels for the selected garment), as mentioned earlier. The step 206 may further include generating the fixed UV map based on the one or more garment panels (not shown in figures).

The spatial information provided by the landmark and segmental parsing network includes landmark predictions (as described earlier with reference to FIG. 4) and segment predictions (as described earlier with reference to). The landmarks (as shown by numbers 1-13 in FIG. 4) are used as the inferred control points by the texture mapping network to warp (or map) the 2D image onto the fixed UV map.

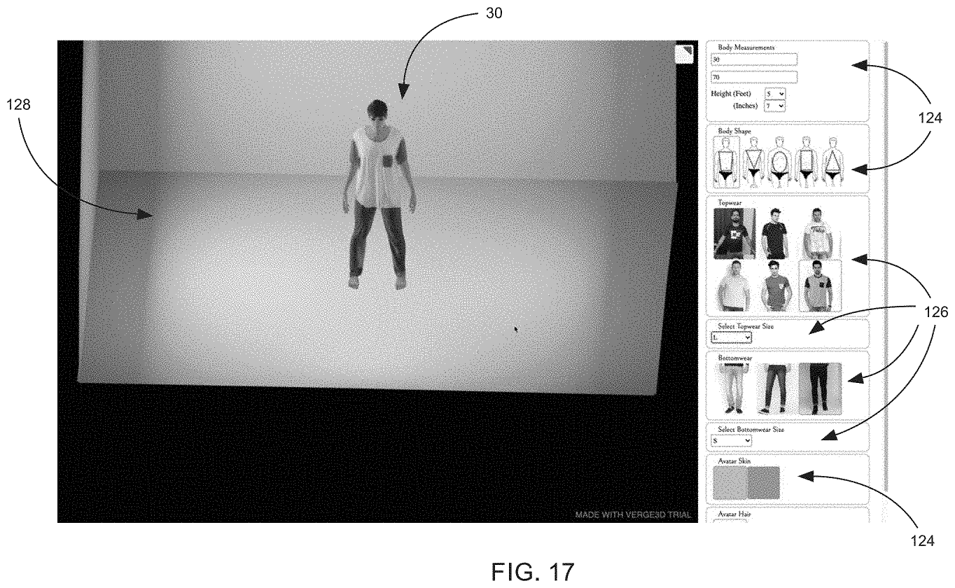

Referring now to FIG. 15, the step 206 of generating the UV map includes, at block 216, providing a plurality of inferred control points corresponding to the 2D image. At block 218, the step 206 includes generating a segmented garment mask based on the 2D image. The step 206, further includes, at block 220, masking the 2D image with the segmented garment mask. At block 222, the step 206 includes warping/mapping the masked 2D image on the fixed UV map based on the plurality of inferred control points and a plurality of fixed control points on the fixed UV map to generate the warped image.

The step 206 further includes, at block 224, adding texture to one or more occluded portions in the warped image to generate the UV map. According to embodiments of the present description, the texture is inferred and added to the occluded portions by training the computer vision model using synthetically generated data as mentioned earlier. The manner of implementation of step 206 is described herein earlier with reference to FIGS. 3-7.

Referring again to FIG. 12, the method 200 includes, at step 208, generating a 3D object corresponding to the selected garment based on the UV map generated by a trained computer vision model and the target 3D model. In some embodiments, the plurality of 3D objects may correspond to a 3D e-catalog model wearing the selected garment in different poses. In some other embodiments, the plurality of 3D objects may correspond to a 3D consumer model wearing the selected garment in different poses.

In some embodiments, a system to virtually fit garments on consumers by generating three-dimensional (3D) objects from two-dimensional (2D) images of garments is presented.

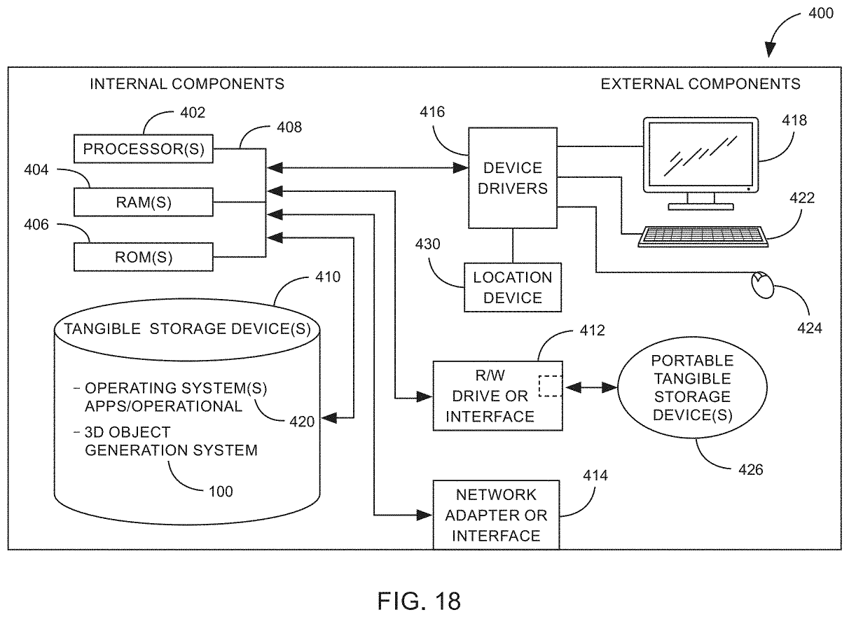

FIG. 16 illustrates an example system 300 for virtually fitting garments on consumers by generating three-dimensional (3D) objects from two-dimensional (2D) images of garments. The system 300 includes a data module 102, a processor 104, and a 3D consumer mode generator 120. The processor 104 includes a computer vision model 106, a training module 108, and a 3D object generator 110.

The 3D consumer model generator 120 is configured to generate a 3D consumer model based on one or more inputs provided by a consumer. The data module 102 is configured to receive a 2D image of a selected garment and the 3D consumer model from the 3D consumer model generator. The computer vision model 106 is configured to generate a 2D map of the 2D image of the selected garment;

The training module 108 is configured to train the computer vision model based on a plurality of 2D training images and a plurality of ground truth (GT) panels for a plurality of 3D training models. The 3D object generator 110 is configured to generate a 3D object corresponding to the selected garment based on the UV map generated by a trained computer vision model and the 3D consumer model, wherein the 3D object is the 3D consumer model wearing the selected garment. Each of these components is described earlier with reference to FIG. 1.

The system 300 may further include a user interface 122 for the consumer to provide inputs as well as select a garment for virtual fitting, as shown in FIG. 16. FIG. 16 illustrates an example user interface 122 where the consumer may provide one or more inputs such as body dimensions, height, body shape, and skin tone using the input selection panel 124. As shown in FIG. 16 the consumer may further select one or more garments and correspond sizes for virtual fitting using the garment selection panel 126. The 3D visual interface 128 further allows the consumer to visualize the 3D consumer model 20 wearing the selected garment, as shown in FIG. 16. The 3D visual interface 128 in such embodiments may be communicatively coupled with the 3D object creator 110.

Embodiments of the present description provide for systems and methods for generating 3D objects from 2D images using a computer vision model trained using synthetically generated data. The synthetic training data is generated by first draping garments on various 3D human bodies at scale by using the information available in clothing panels used by the fashion designers while stitching the garments. The resulting 3D training models are employed to generate a plurality of ground truth panels and a plurality of 2D training images by encoding the garment texture in training UV maps generated from the 3D training models. Thus, generating synthetic data capable of training the computer vision model to generate high-resolution 3D objects with corresponding clothing texture.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

One example of a computing system 400 is described below in FIG. 17. The computing system 400 includes one or more processor 402, one or more computer-readable RAMs 404 and one or more computer-readable ROMs 406 on one or more buses 408. Further, the computer system 408 includes a tangible storage device 410 that may be used to execute operating systems 420 and 3D object generation system 100. Both, the operating system 420 and the 3D object generation system 100 are executed by processor 402 via one or more respective RAMs 404 (which typically includes cache memory). The execution of the operating system 420 and/or 3D object generation system 100 by the processor 402, configures the processor 402 as a special-purpose processor configured to carry out the functionalities of the operation system 420 and/or the 3D object generation system 100, as described above.

Examples of storage devices 410 include semiconductor storage devices such as ROM 504, EPROM, flash memory or any other computer-readable tangible storage device that may store a computer program and digital information.

Computing system 400 also includes a R/W drive or interface 412 to read from and write to one or more portable computer-readable tangible storage devices 4246 such as a CD-ROM, DVD, memory stick or semiconductor storage device. Further, network adapters or interfaces 414 such as a TCP/IP adapter cards, wireless Wi-Fi interface cards, or 3G or 4G wireless interface cards or other wired or wireless communication links are also included in the computing system 400.

In one example embodiment, the 3D object generation system 100 may be stored in tangible storage device 410 and may be downloaded from an external computer via a network (for example, the Internet, a local area network or another wide area network) and network adapter or interface 414.

Computing system 400 further includes device drivers 416 to interface with input and output devices. The input and output devices may include a computer display monitor 418, a keyboard 422, a keypad, a touch screen, a computer mouse 424, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for generating three-dimensional (3D) objects from two-dimensional (2D) images of garments, the system comprising:
a data module configured to receive a 2D image of a selected garment and a target 3D model;
a computer vision model configured to generate a UV map of the 2D image of the selected garment;
a training module configured to train the computer vision model based on a plurality of 2D training images and a plurality of ground truth (GT) panels for a plurality of 3D training models; and
a 3D object generator configured to generate a 3D object corresponding to the selected garment based on the UV map generated by a trained computer vision model and the target 3D model.

2. The system of claim 1, wherein the computer vision model comprises:
a landmark and segmental parsing network configured to provide spatial information corresponding to the 2D image;
a texture mapping network configured to map the 2D image onto a fixed UV map based on the spatial information corresponding to the 2D image to generate a warped image; and
an inpainting network configured to add texture to one or more occluded portions in the warped image to generate the UV map.

3. The system of claim 2, wherein the landmark and segmental parsing network is configured to provide a plurality of inferred control points corresponding to the 2D image, and
the texture mapping network is configured to map the 2D image onto the fixed UV map based on the plurality of inferred control points and a plurality of corresponding fixed control points on the fixed UV map.

4. The system of claim 3, wherein the landmark and segmental parsing network is further configured to generate a segmented garment mask, and
the texture mapping network is configured to mask the 2D image with the segmented garment mask and map the masked 2D image onto the fixed UV map based on the plurality of inferred control points.

5. The system of claim 1, further comprising a training data generator configured to generate the plurality of GT panels and the plurality of 2D training images, based on UV maps, by varying one or more of model poses, lighting conditions, garment textures, garment colours, or camera angles for the plurality of 3D training models.

6. The system of claim 5, further comprising a 3D training model generator configured to generate the plurality of 3D training models based on a plurality of target model poses and garment panel data.

7. The system of claim 1, wherein the target 3D model comprises a plurality of 3D catalog models in different poses.

8. The system of claim 1, wherein the target 3D model is a 3D consumer model generated based on one or more of body dimensions, height, body shape, and skin tone provided by a consumer.

9. A system configured to virtually fit garments on consumers by generating three-dimensional (3D) objects from two-dimensional (2D) images of garments, the system comprising:
a 3D consumer model generator configured to generate a 3D consumer model based on one or more information provided by a consumer;
a data module configured to receive a 2D image of a selected garment and the 3D consumer model;
a computer vision model configured to generate a 2D map of the 2D image of the selected garment;
a training module configured to train the computer vision model based on a plurality of 2D training images and a plurality of ground truth (GT) panels for a plurality of 3D training models; and
a 3D object generator configured to generate a 3D object corresponding to the selected garment based on the UV map generated by a trained computer vision model and the 3D consumer model, wherein the 3D object is the 3D consumer model wearing the selected garment.

10. The system of claim 9, wherein the computer vision model comprises:
a landmark and segmental parsing network configured to provide spatial information corresponding to the 2D image;
a texture mapping network configured to map the 2D image onto a fixed UV map based on the spatial information corresponding to the 2D image to generate a warped image; and
an inpainting network configured to add texture to one or more occluded portions in the warped image to generate the UV map.

11. The system of claim 10, wherein the landmark and segmental parsing network is configured to provide a plurality of inferred control points corresponding to the 2D image, and
the texture mapping network is configured to map the 2D image onto the fixed UV map based on the plurality of inferred control points and a plurality of corresponding fixed control points on the fixed UV map.

12. The system of claim 11, wherein the landmark and segmental parsing network is further configured to generate a segmented garment mask, and
the texture mapping network is configured to mask the 2D image with the segmented garment mask and map the masked 2D image onto the fixed UV map based on the plurality of inferred control points.

13. The system of claim 8, further comprising a training data generator configured to generate the plurality of ground truth (GT) panels and 2D training images, based on UV maps, by varying one or more of model poses, lighting conditions, garment textures, garment colours, or camera angles for the plurality of 3D training models.

14. A method for generating three-dimensional (3D) objects from two-dimensional (2D) images of garments, the method comprising:
receiving a 2D image of a selected garment and a target 3D model;
training a computer vision model based on a plurality of 2D training images and a plurality of ground truth panels for a plurality of 3D training models;
generating a UV map of the 2D image of the selected garment based on the trained computer vision model; and
generating a 3D object corresponding to the selected garment based on the UV map generated by a trained computer vision model and the target 3D model.

15. The method of claim 14, wherein the computer vision model comprises:
a landmark and segmental parsing network configured to provide spatial information corresponding the 2D image;
a texture mapping network configured to map the 2D image onto a fixed UV map based on the spatial information corresponding to the 2D image to generate a warped image; and
an inpainting network configured to add texture to one or more occluded portions in the warped image to generate the UV map.

16. The method of claim 15, wherein the landmark and segmental parsing network is configured to provide a plurality of inferred control points corresponding to the 2D image, and
the texture mapping network is configured to map the 2D image onto the fixed UV map based on the plurality of inferred control points and a plurality of corresponding fixed control points on the fixed UV map.

17. The method of claim 16, wherein the landmark and segmental parsing network is further configured to generate a segmented garment mask, and
the texture mapping network is configured to mask the 2D image with the segmented garment mask and map the masked 2D image onto the fixed UV map based on the plurality of inferred control points.

18. The method of claim 14, further comprising generating the plurality of ground truth (GT) panels and the plurality of 2D training images, based on UV maps, by varying one or more of model poses, lighting conditions, garment textures, garment colours, or camera angles for the plurality of 3D training models.

19. The method of claim 14, wherein the target 3D model comprises a plurality of 3D catalog models in different poses.

20. The method of claim 14, wherein the target 3D model is a 3D consumer model generated based on one or more of body dimensions, height, body shape, and skin tone provided by a consumer.
